(19) United States
(12) Patent Application Publication
(10) Pub. No.: US 2007/0165942 A1
(43) Pub. Date: Jul. 19, 2007

(54) Method for rectifying stereoscopic display systems

(75) Inventors: Elaine W. Jin, Webster, NY (US); Michael E. Miller, Honeoye Falls, NY (US); Shoupu Chen, Rochester, NY (US); Mark R. Bolin, Fairport, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/334,275

(22) Filed: Jan. 18, 2006

(51) Int. Cl. G06K 9/00

(52) U.S. Cl. 382/154

(57) ABSTRACT

A method for rectifying misalignment in a stereoscopic display system (140) comprises: providing a pair of input images to an image processor (120); creating an image source displacement map for the pair of input images; obtaining a display displacement map (150); and applying the image source displacement map and the display displacement map to the pair of input images to create a rectified stereoscopic image pair.

### FIELD OF THE INVENTION

The invention relates generally to the field of stereoscopic capture, processing, and display systems. More specifically, the invention relates to a stereoscopic system that provides a way to compensate for spatial misalignment in source images and in the display system using image-processing algorithms.

### BACKGROUND OF THE INVENTION

The normal human visual system provides two separate views of the world through our two eyes. Each eye has a horizontal field of view of about 60 degrees on the nasal side and 90 degrees on the temporal side. A person with two eyes, not only has an overall broader field of view, but also has two slightly different images formed at his/her two retinas, thus forming different viewing perspectives. In normal human binocular vision, the disparity between the two views of each object is used as a cue by the human brain to derive the relative depth between objects. This derivation is accomplished by comparing the relative horizontal displacement of corresponding objects in the two images.

Stereoscopic displays are designed to provide the visual system with the horizontal disparity cue by displaying a different image to each eye. Known stereoscopic displays typically display a different image to each of the observers' two eyes by separating them in time, wavelength or space. These systems include using liquid crystal shutters to separate the two images in time, lenticular screens, barrier screens or autostereoscopic projection to separate the two images in space, and the use of color filters or polarizers to separate the two images based on optical properties.

It is to be understood that while the two eyes are generally displaced in the horizontal direction, they are generally not displaced in the vertical direction. Therefore, while horizontal disparities are expected, vertical disparities are not expected and can significantly degrade the usefulness of a stereoscopic display system. For example, vertical displacement or misalignment existing between corresponding objects in the two images will reduce the viewer's ability to fuse the two images into a single perceive image, and the viewer is likely to experience visual fatigue and other undesirable side effects. When the amount of misalignment is small, the presence of vertical disparity results in eyestrain, degraded depth, and partial loss of depth perception. When the amount of vertical misalignment is large, vertical disparity may result in binocular rivalry and the total loss of depth perception.

Vertical misalignment can be introduced into stereoscopic images at various stages, including during image capture and image display. During image capture, a stereo image pair is typically recorded with either image of the image pair being captured through a different optical system, which may themselves not always be aligned vertically; or two images are recorded by using one camera and laterally shifting the camera between captures, during which the vertical position of the camera can change. When the capture system is off on vertical misalignment, all pixels of the stereo pair may be off by a certain amount vertically. Keystone distortion can also be created if the cameras are not positioned parallel to one another as is often required to capture objects that are close to the capture system. This keystone distortion often reduces the vertical size of objects that are positioned at opposite sides of the scene, and this keystone distortion results in a vertical misalignment of a different amount for different pixels in the stereo pair. The vertical misalignment due to keystone distortion can, therefore, be much larger at the corners of the images compared to the center of the images. The two captures can also have rotational or magnification differences, causing vertical misalignment in the stereo images. The vertical misalignment from rotational and magnification difference are generally larger at the corners of the images, and smaller at places close to the center of the images. Usually the vertical misalignment of the stereo images is a result of a combination of the factors mentioned above. A scanning process can also cause this type of vertical misalignment if the images are captured or stored on an analog medium, such as film, and a scanner is used to convert the analog images to digital.

Vertical disparity can also be produced by a vertical misalignment or rotation or magnification of the display optics. Many stereoscopic display systems have two independent imaging channels, each consisting of numerous optical and display components. It would be very difficult to manufacture two identical components to use for the two channels. In addition, it is also very difficult to assemble the system so that the two imaging channels are identical to each other in vertical position and offset precisely in horizontal position. As a result, various spatial mismatches can be introduced between the two imaging channels. Those spatial mismatches in display systems are manifested as spatial displacement in the stereo images. In the stereo images horizontal displacement can generally be interpreted as differences in depth while vertical displacement can lead to user discomfort. Stereoscopic systems that may present images with some degree of vertical displacement (e.g., helmet-mounted displays) typically have a very tight tolerance for relative display. The presence of this tight tolerance often complicates the manufacture and increases the cost of producing such devices.

Image-processing algorithms have been used to correct for the spatial misalignment created in stereoscopic capture systems. U.S. Pat. No. 6,191,809 and EP 1 235 439 A2 discusses a means for electronically correcting for misalignment of stereo images generated by stereoscopic capture devices, in particular, by stereo endoscopes. A target in the capture space is used for calibration. From the captured left and right images of the target magnification and rotational errors of the capture device are estimated in sequence, and used to correct the captured images. The horizontal and vertical offsets are estimated based on a second set of captured images of the target that have been corrected for magnification and rotational errors.

U.S. Patent Application Publication No. 2003/0156751 A1 describes a method for determining a pair of rectification transformations to rectify the two captured images to substantially eliminate vertical disparity from the rectified image pair. The goal of rectification is to transform the stereo image pair from a non-parallel camera setup to a virtual parallel camera set-up. This method takes as inputs both the captured images, and the statistics of parameters of the stereoscopic image capture device. The parameters may include intrinsic parameters such as the focal length and principal point of a single camera, and extrinsic parameters such as the rotation and translation between the two cameras. A warping method is used to apply the rectification transformation to the stereo image pair. Each of the references mentioned above requires information about the capture devices, or to link the image-processing system to the capture process. In the case of unknown image source, the methods described above will not function properly.

It has also been recognized that there is a need to align certain components of a stereoscopic display system. U.S. Patent Application Publication No. 2004/0263970 A1 discloses a method of aligning an array of lenticular lenses to a display using software means. The software consists of a program that will provide test patterns to aid in positioning the lenticular array over the array of pixels on the display. In the alignment phase, the user would use some input means to indicate the rotational positions of test patterns shown on the display relative to the lenticular screen. The information determined by the alignment phase of the installation is subsequently stored in the computer, allowing rendering algorithms to compensate for the rotation of the lenticular screen with respect to the underlying pixel pattern on the display. While the actual algorithm of doing software processing to compensate for the rotational alignment of the lenticular screen is not described in the document, it would be expected that the misalignment of the lenticular screen would result primarily in horizontal shifts in the location of the pixels that will be seen by the left versus the right eye, and this algorithm would be expected to compensate for this artifact. Therefore, this reference does not provide a method for compensating for vertical misalignment within the stereoscopic display system.

There is a need, therefore, for creating a stereoscopic display system that can minimize overall spatial misalignment between the two stereo images without knowledge of the capture system. There is further a need for a method to compensate for the vertical and horizontal spatial misalignment in the display system. This method should further be robust, require a minimal processing time such that it may be performed in real time, and require minimal user interaction.

### SUMMARY OF THE INVENTION

The present invention is directed to overcoming one or more of the problems set forth above. According to one aspect of the present invention, an image-processing algorithm is developed to correct the vertical misalignment introduced in the image capturing/producing process without prior knowledge of the causes. This image-processing algorithm compares the two images and registers one image to the other. The image registration process creates two displacement maps for both the horizontal and vertical directions. The algorithm applies the vertical displacement to one or both of the images to make the two images well aligned in the vertical direction. The method of the present invention also generates a display displacement map using a pair of test targets, a twin video camera set, a video mixer, and a video monitor. This displacement map can be further used by an image warping algorithm to pre-processing the stereo images, and hence to compensate for any spatial misalignment introduced in the display system. Overall, the present invention provides an integrated solution to minimize the spatial misalignment caused by either the source or the display device in a stereoscopic display system.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a diagram of the system employed in the practice of the present invention;

FIG. 2a is a flow chart showing the method of image vertical misalignment correction of the present invention;

FIG. 2b shows a system using the method introduced in FIG. 2a;

FIG. 3 is an exemplary result of image vertical misalignment correction;

FIG. 4 is a flow chart showing the steps of compensating for display system misalignment in the present invention;

FIG. 5 is an illustration of a capture system for recording display system displacement map;

FIG. 6 is an example test targets used in display misalignment compensation;

FIG. 7 is an exemplary result of display system misalignment compensation;

FIG. 8a is a flow chart showing the method of display misalignment correction of the present invention; and

FIG. 8b shows a system using the method introduced in FIG. 8a.

To facilitate understanding, identical reference numerals have been used, where possible, to designate identical elements that are common to the figures.

### DETAILED DESCRIPTION OF THE INVENTION

The present description is directed in particular to elements forming, part of, or cooperating more directly with, apparatus in accordance with the invention. It is to be understood that elements not specifically shown or described may take various forms well known to those skilled in the art.

The present invention is directed towards a method for rectifying misalignment in a stereoscopic display system comprising: providing an input image to an image processor; creating an image source displacement map; obtaining a display displacement map; and applying the image source displacement map and the display displacement map to the input image to create a rectified stereoscopic image pair. The image source displacement map and the display displacement map may be combined to form a system displacement map and this map may be applied to the input image in a single step. Alternatively, the image source displacement map and the display displacement map may alternately be applied to the input image in separate steps. Further provided is a system employing the method of the present invention. Further methods are provided for forming and applying the image source displacement map based upon an analysis of the input image and for forming and applying the display displacement map.

The present invention is useful when applied within a stereoscopic imaging system in which one or more components of the system introduce some degree of spatial misalignment that can create discomfort for a human observer. The vertical misalignment of source images is compensated for by computing image transformation functions for a pair of stereo images, indicating the degree to which one image must be transformed to align to a second image; applying the vertical compensation to generate vertical displacement maps; computing working displacement maps for at least one of the stereo images; and correcting for the vertical displacement by deforming the stereo images using the computed working displacement maps. Such a processing chain may additionally consider display attributes by forming displacement maps that contain both vertical and horizontal displacements to compensate for vertical or horizontal displacements formed by misalignment of the display. The spatial misalignment of the display system is compensated by creating a display system displacement map, and applying a warping algorithm to pre-process one or more of the images so that the viewer will perceive stereo image pairs with minimal system introduced spatial misalignment.

Such an image processing chain may improve the comfort and the quality of the stereoscopic image viewing experience. This invention is based on the research results by the authors in which images containing vertical disparities were shown to induce discomfort. This improvement in viewing experience will often result in increased user comfort or enhanced viewing experience in terms of increasing user enjoyment, engagement and/or presence. This improvement may also be linked to the improvement in the performance of the user during the completion of a task such as the estimation of distances or depths within the images represented by the stereoscopic image pairs.

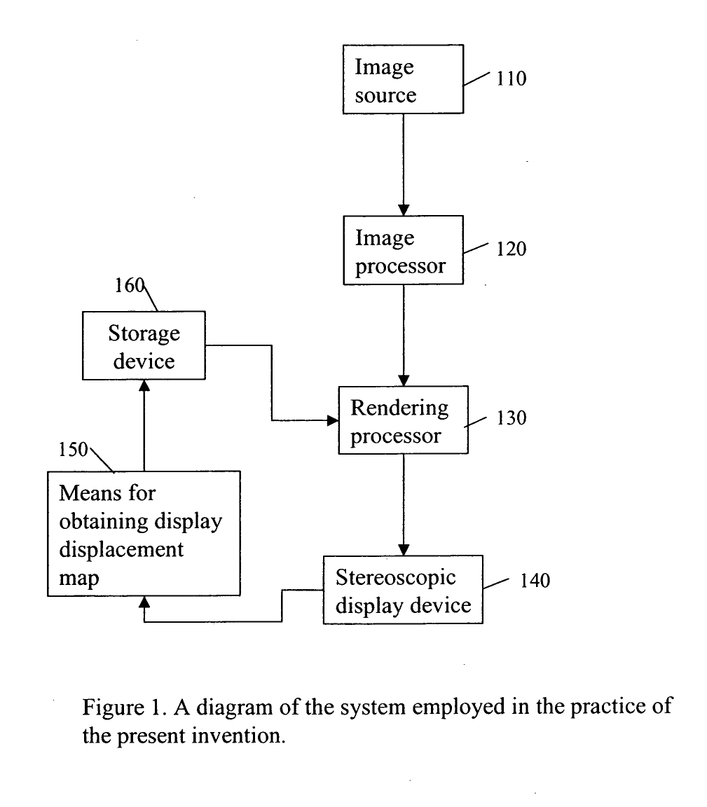

A system useful in practicing the present invention is shown in FIG. 1. This system includes an image source 110 for obtaining stereoscopic image information or computer graphics models and textures, an image processor 120 for extracting the horizontal and vertical displacement maps from the image source, and to process the input images to minimize the vertical misalignment, a rendering processor 130 for rendering the stereoscopic images, and a stereoscopic display device 140 for displaying the rendered stereoscopic pair of images. This system also has a means to obtain the display displacement map 150, and a storage device 160 to store the display distortion map. In the rendering processor 130 this display displacement map is used to re-render the images from image processor 120 to compensate for the misalignment in the display system.

The image source 110 may be any device or combination of devices that are capable of providing stereoscopic image information. For example, this image source may include a pair of still or video cameras capable of capturing the stereoscopic image information. Alternately, the image source 110 may be a server that is capable of storing one or more stereoscopic images. The image source 110 may also consist of a memory device capable of providing definitions of a computer generated graphics environment and textures that can be used by the image processor to render a stereoscopic view of a three dimensional graphical environment.

The image processor 120 may be any processor capable of performing the calculations that are necessary to determine the misalignment between a pair of stereoscopic images that have been retrieved from the image source 110. For example, this processor may be any application specific integrated circuit (ASIC), programmable integrated circuit or general-purpose processor. The image processor 120 performs the needed calculations based on information from the image source 110.

The rendering processor 130 may be any processor capable of performing the calculations that are necessary to apply a warping algorithm to a pair of input images to compensate for the spatial misalignment in the display system. The calculation is based on information from image processor 120 and from storage device 160. The rendering processor 130 and the image processor 120 may be two separate devices, or may be the same device.

The stereoscopic display device 140 may be any display capable of providing a stereoscopic pair of images to a user. For example, the stereoscopic display device 140 may be a direct view device that presents an image at the surface of the display (i.e., has a point of accommodation and convergence at the plane of the display surface); such as a barrier screen liquid crystal display device, a CRT with liquid crystal shutters and shutter glasses, a polarized projection system with linearly or circular polarized glasses, a display employing lenticules, a projected autostereoscopic display, or any other device capable of presenting a pair of stereographic images to each of the left and right eyes at the surface of the display. The stereoscopic display device 140 may also be a virtual image display that displays the image at a virtual location, having adjustable points of accommodation and convergence; such as an autostereoscopic projection display device, a binocular helmet-mounted display device or retinal laser projection display.

The means for obtaining a display displacement map 150 may include a display device to display a stereoscopic image pair having a known spatial arrangement of points, a pair of stereoscopic cameras to capture the left and right images, and a processor to compare the two images to derive the display displacement map. The capture can be obtained with any still digital cameras or with video cameras as long as the spatial alignment of the two cameras is known. Alternately, the means for obtaining a display displacement map may include a display device to display a stereoscopic image pair having a known spatial arrangement, a user input device for allowing the user to move at least one of the images in the stereoscopic image pair for obtaining correspondence between two points and a method for determining the displacement of the images when the user indicates that correspondence is achieved. It should be noted that targets useful for automated alignment may not be adequate when the means for obtaining the display displacement map is obtained based upon user alignment. Because the eyes of the user cannot be aligned in a fixed location, and because the human brain will attempt to align targets which have similar spatial structure on the stereoscopic display, the targets presented on the left and right screens must be designed to have little spatial correlation. One method to achieve this is to display primarily horizontal lines to one eye and vertical lines to the other eye. By using targets in which a horizontal or vertical line is displayed to one eye and asking the user to align this line to a gap in a line shown to the other eye, little spatial correlation exist between the two eye images, allowing the targets to be adjusted to fall the same place on the two human retinas when the user's eyes are near their natural resting point.

The display displacement map will be stored in storage device 160, and will be used as input to the rendering processor 130. This map will be used to process the input images from image processor 120 to compensate for the horizontal as well as vertical misalignment of the display device.

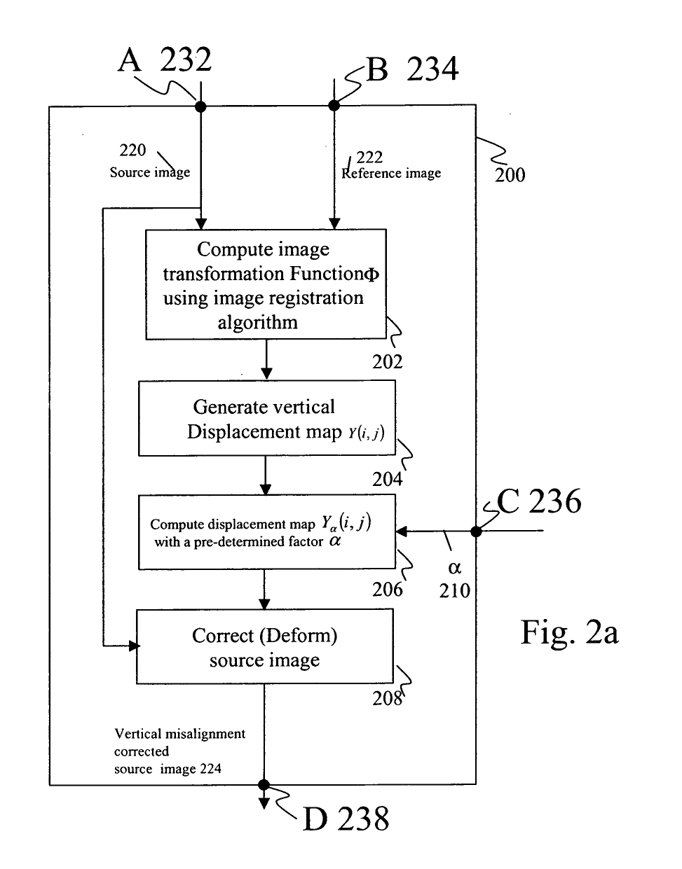

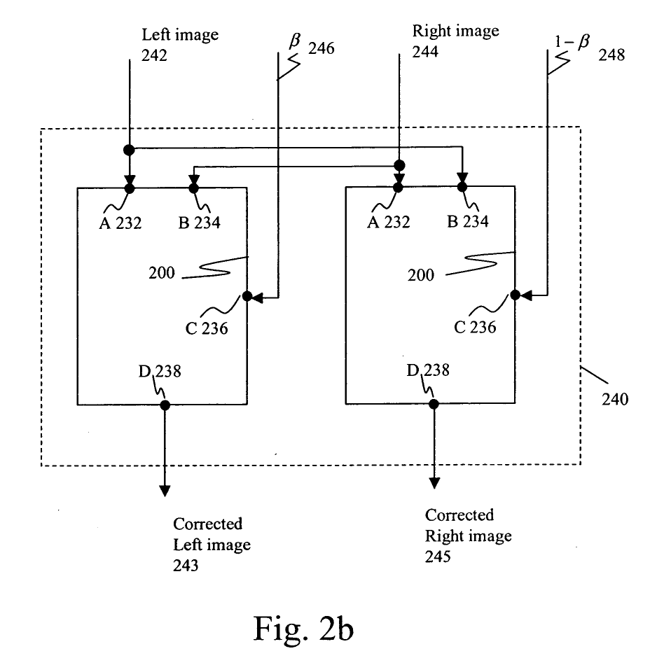

Referring now to FIG. 2a, the flow chart of the method of image vertical misalignment correction of the present invention is shown. The correction of vertical misalignment in stereoscopic visualization can be modeled as an image registration problem. The process of image registration is to determine a mapping between the coordinates in one space (a two dimensional image) and those in another (another two dimensional image), such that points in the two spaces that correspond to the same feature point of an object are mapped to each other. The key to correction of vertical misalignment in stereoscopic visualization is to determine a mapping between the coordinates of two images involved in the stereoscopic visualization process. The process of determining a mapping between the coordinates of two images provides a horizontal displacement map and a vertical displacement map of corresponding points in the two images. The found vertical displacement map is then used to deform at least one of the involved images to minimize the vertical misalignment.

In terms of image registration terminology the two images involved in stereoscopic visualization are referred as a source image 220 and a reference image 222. Denote the source image and the reference image by I(xₜ, yₜ, t) and I(xₜ₊₁, yₜ₊₁, t+1) respectively. The notations x and y are the horizontal and vertical coordinates of the image coordinate system, and t is the image index (image 1, image 2, etc.). The origin, (x=0, y=0), of the image coordinate system is defined at the center of the image plane. It should be pointed that the image coordinates, x and y, are not necessarily integers.

For the convenience of implementation, the image (or image pixel) is also indexed as I(i, j) where i, and j are strictly integers and parameter t is ignored for simplicity. This representation aligns with indexing a matrix in the discrete domain. If the image (matrix) has a height of h and a width of w, the corresponding image plane coordinates x and y at location (i, j) can be computed as x=i−(w−1)/2.0, and y=(h−1)/2.0−j. The column index i runs from 0 to w−1. The row index j runs from 0 to h−1.

In general, the registration process involves finding an optimal transformation function Φₜ₊₁(xₜ, yₜ) (see step 202) such that
[xₜ₊₁,yₜ₊₁,1]^{T}=Φ(xₜ,yₜ)[xₜ,yₜ,1]^{T} (10-1)

The transformation function of Equation (10-1) is a 3×3 matrix with elements shown in Equation (10-2).

$$Φ = [ \begin{matrix}{ϕ}_{00} & {ϕ}_{01} & {ϕ}_{02} \\ {ϕ}_{10} & {ϕ}_{11} & {ϕ}_{12} \\ 0 & 0 & 1\end{matrix} ] \qquad ( 10 \text{-} 2 )$$

In fact, the transformation matrix consists of two parts, a rotation sub-matrix

$$[ \begin{matrix}{ϕ}_{00} & {ϕ}_{01} \\ {ϕ}_{10} & {ϕ}_{11}\end{matrix} ]$$

and a translation vector

$$[ \begin{matrix}{ϕ}_{02} \\ {ϕ}_{12}\end{matrix} ] :$$

Note that the transformation function Φ is either a global function or a local function. A global function Φ transforms every pixel in an image in the same manner. A local function Φ transforms each pixel in an image differently based on the location of the pixel. For the task of image registration, the transformation function Φ could be a global function or a local function or a combination of the two.

In practice, the transformation function Φ generates two displacement maps, X(i, j), and Y(i, j), which contain the information that could bring pixels in the source image to new positions that align with the corresponding pixel positions in the reference image. In other words, the source image is to be spatially corrected.

It is clear that in the case of stereoscopic visualization for human viewers, only the vertical direction displacement map Y(i, j) (step 204) is needed to bring the pixels in the source image to new positions that align, in the vertical direction, with the corresponding pixels in the reference image. This vertical alignment will correct the discomfort caused by the varying vertical misalignment due to, for example, perspective distortion. For the displacement map Y(i, j), the column index i runs from 0 to w−1 and the row index j runs from 0 to h−1.

In practice, to generalize the correction of vertical misalignment using the displacement Y(i, j), a working displacement map Y_{α}(i, j) is introduced. The working displacement map Y_{α}(i, j) is computed with a pre-determined factor α of a particular value (step 206) as
Y_{α}(i,j)=αY(i,j).
where 0≦α≦1. The generated working displacement map Y_{α}(i, j) is then used to deform the source image (step 208) to obtain a vertical misalignment corrected source image 224. The introduction of a working displacement Y_{α}(i, j) facilitates the correction of vertical misalignment for both images (left and right) when the need arises. The process of correction of vertical misalignment for both images (left and right) is explained below.

It is clear that the roles of source and reference images are exchangeable for the two images (left and right images) involved in the context of correction of vertical misalignment in stereoscopic visualization.

In general, to correct the discomfort caused by the varying vertical misalignment due to, for example, perspective distortion, both the left and right images could be spatially corrected with working displacement maps Y_{α}(i, j) computed with a pre-determined factor α of particular values.

As shown in FIG. 2a, the process of vertical misalignment correction can be represented by a box 200 with three input terminals A (232), B (234) and C (236), and one output terminal D (238). With this arrangement, the structure of the vertical misalignment correction for both the left 242 and right 244 images can be constructed as an image processing system 240 shown in FIG. 2b. There are two identical boxes 200 in the image processing system 240. Two scaling factors β (246) and 1−β (248) are used to determine the amount of deformation for the left 242 and right 244 images respectively. These two parameters β (246) and 1−β (248) ensure that the corrected left image 243 and right image 245 are aligned vertically. The valid range for β is 0≦β≦1. When β=0, the corrected left image 243 is the input left image 242 and the corrected right image 245 aligns with the input left image 242. When β=1, the corrected right image 245 is the input right image 244 and the corrected left image 243 aligns with the input right image 244. When β≠0 and β≠1, both the left image 242 and right image 244 go through the correction process and the corrected left image 243 and corrected right image 245 are aligned somewhere between the left image 242 and the right image 244, depending on the value of β.

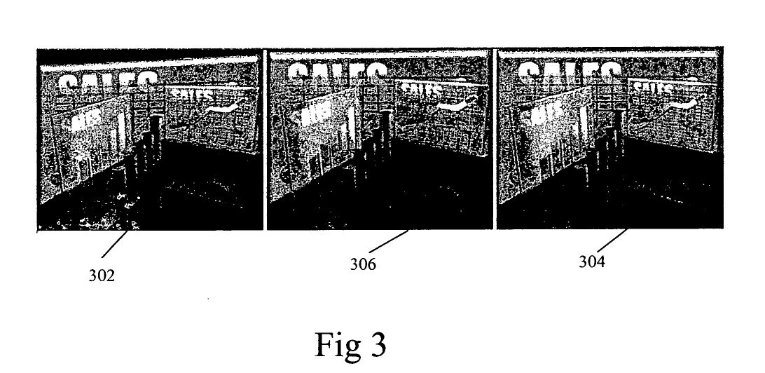

An exemplary result of vertical misalignment correction is shown in FIG. 3. In FIG. 3, on the left is the source image 302; on the right is the reference image 304. Clearly, there are varying vertical misalignments in columns between the source image 302 and the reference image 304. By applying the steps shown in FIG. 2 to these two images, the vertical misalignment corrected source 306 image is obtained. In this exemplary case, the parameter α=1.

Note that the registration algorithm used in computing the image transformation function Φ could be a rigid registration algorithm, a non-rigid registration algorithm or a combination of the two. People skilled in the art understand that there are numerous registration algorithms that are typically used to register images that are captured at different time intervals or to assess the horizontal disparity of different objects in order to determine depth or distance from stereoscopic image pairs. However, these same algorithms can carry out the task of finding the transformation function Φ that generates the needed displacement maps for the correction of the vertical misalignment in stereoscopic visualization by performing this registration in the vertical dimension for left and right eye images. Exemplary registration algorithms can be found in “Medical Visualization with ITK”, by Ibanez, L., et al. at http://www.itk.org. Also people skilled in the art understand that spatially correcting an image with a displacement map could be realized by using any suitable image interpolation algorithms (see “Robot Vision” by Horn, B., The MIT Press, pp. 322 and 323.)

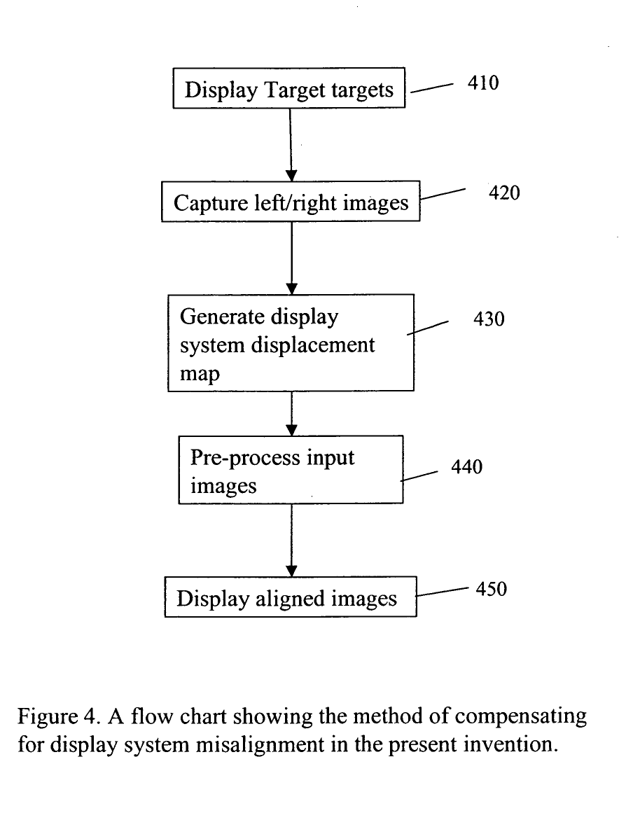

Having discussed a method for creating an image source displacement map, a method for determining a display displacement map can be addressed. Referring to FIG. 4, which is a flow chart showing the method of compensating for display system misalignment in the present invention, one can see that the preferred method generally consists of: displaying a pair of test targets 410; capturing the left and right images 420, which will typically be performed using a pair of spatially calibrated cameras; generating a display system displacement map 430 from the left and right captured images. This information is stored in the computer, and is used to pre-process the input stereoscopic images 440. The last step is to display the aligned images 450 to the left and right imaging channels of the display.

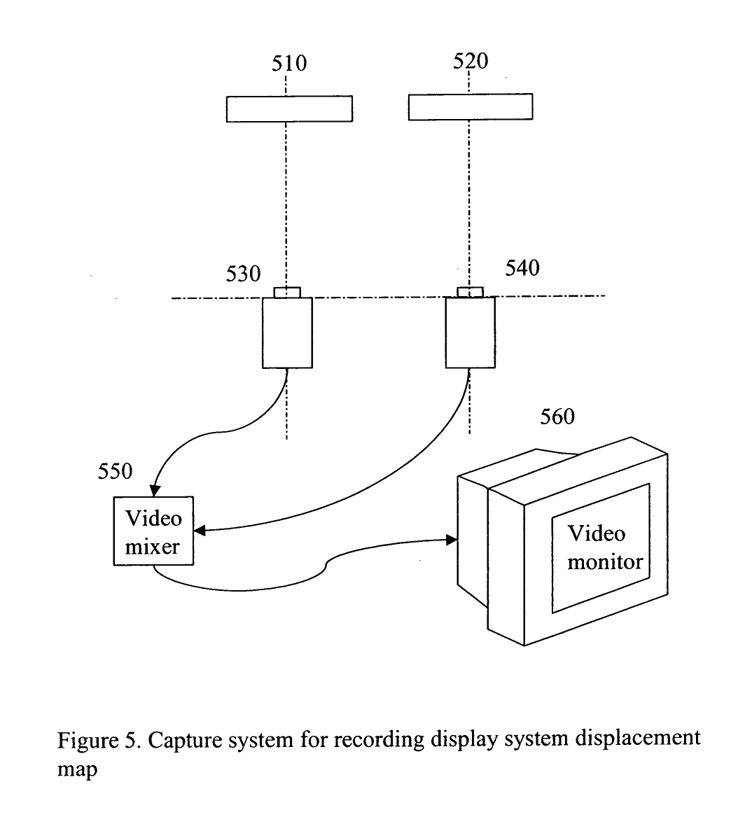

An exemplar measurement system is shown in FIG. 5. This system has a twin digital video camera set 530 and 540 (e.g. SONY color video camera CVX-V18NS), a regular color monitor 560, and a video signal mixer 550. The video cameras focus on the test target 510 and 520. The video signals from the left and the right channels are combined using the video mixer 550, and are displayed on the color monitor 560. Prior to image capture, the spatial position of these cameras may be calibrated by placing the cameras at a horizontal separation consistent with the assumed inter-ocular distance of the stereo display, aiming both the cameras at a single test target positioned at optical infinity and adjusting the cameras response to eliminate any spatial misalignment. Although the resulting images may be viewed on the video mixer, high resolution captures of each of the calibration points on the two test targets may be digitally stored for later analysis.

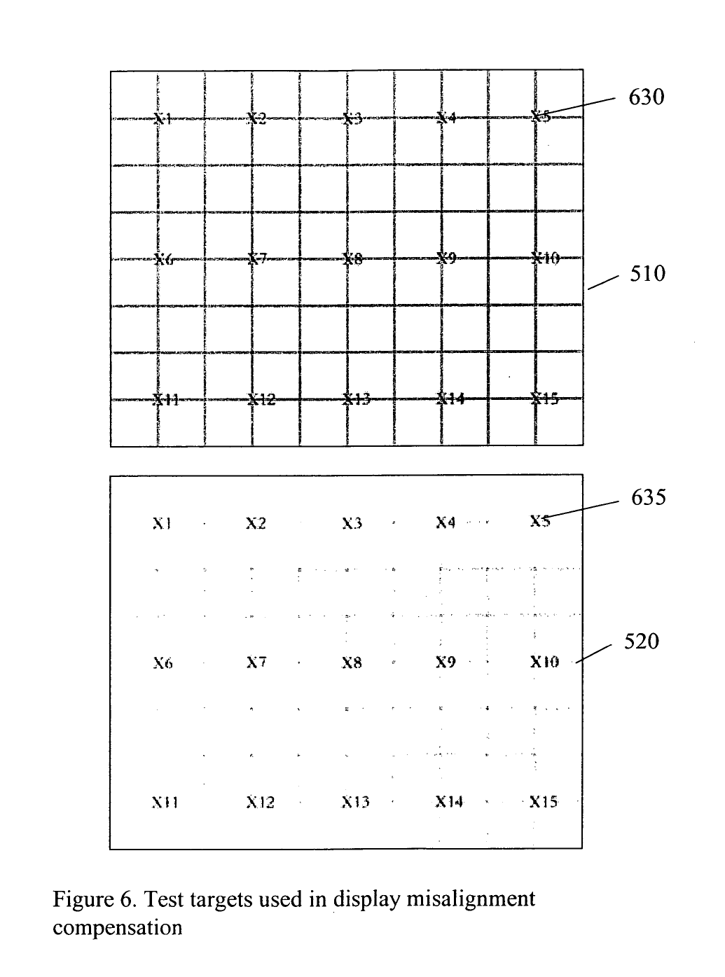

FIG. 6 shows a pair of exemplar test targets 510 and 520. They are identical except for the color. For example, the target sent to the left channel 510 is red while that sent to the right channel 520 is green. This is to ensure that the left and right target images are separable visually on the color monitor 560 as well as identifiable from an algorithmic standpoint. There are anchor points 630 and 635 on the test targets 510 and 520. This system was used to measure the spatial misalignment at the anchored locations. Because there were no nominal positions for the measurement to compare to, the measurements were obtained as a deviation of the left channel from the right channel. A sign was assigned to the deviation such that it was positive if the left location was to the right of the right location (in Δx), or it was above the right location (in Δy).

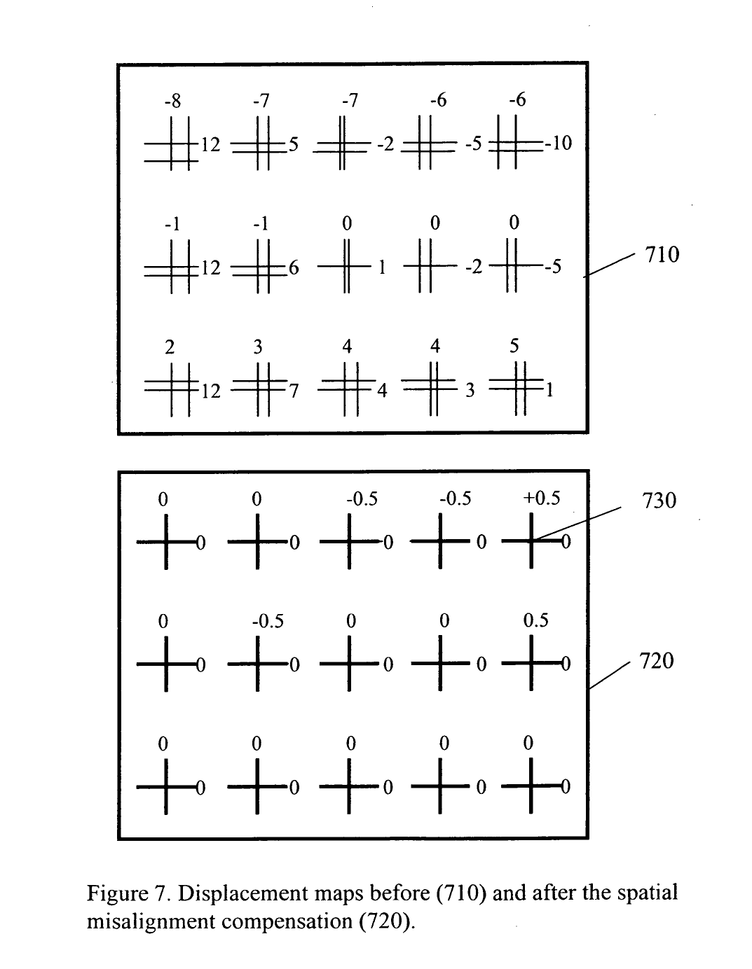

An exemplar, measurement results of the display displacement map is shown in FIG. 7. Image 710 is an image of overlaid anchor points from the left and right cameras for one exemplar stereoscopic display system. It shows that the maximum horizontal deviation occurred on the left side, and had a magnitude of 12 pixels. The maximum vertical deviation occurred on the top left corner, and had a magnitude of 8 pixels. Overall the left channel image is smaller compared to the right channel image. A warping algorithm can be used to compensate for the spatial misalignment of the display system by pre-processing the input stereo images. This algorithm takes as inputs the input images and the displacement map of the display system. The output is a transformed image pair, which when viewed, is free of any horizontal or vertical misalignment from the display system. Image 720 is an image of the overlaid anchor points from the two target images after correction for misalignment. It shows perfect alignment in most anchor locations. The errors in some anchor locations 730 reflect the quantization errors related to the digital nature of the display system.

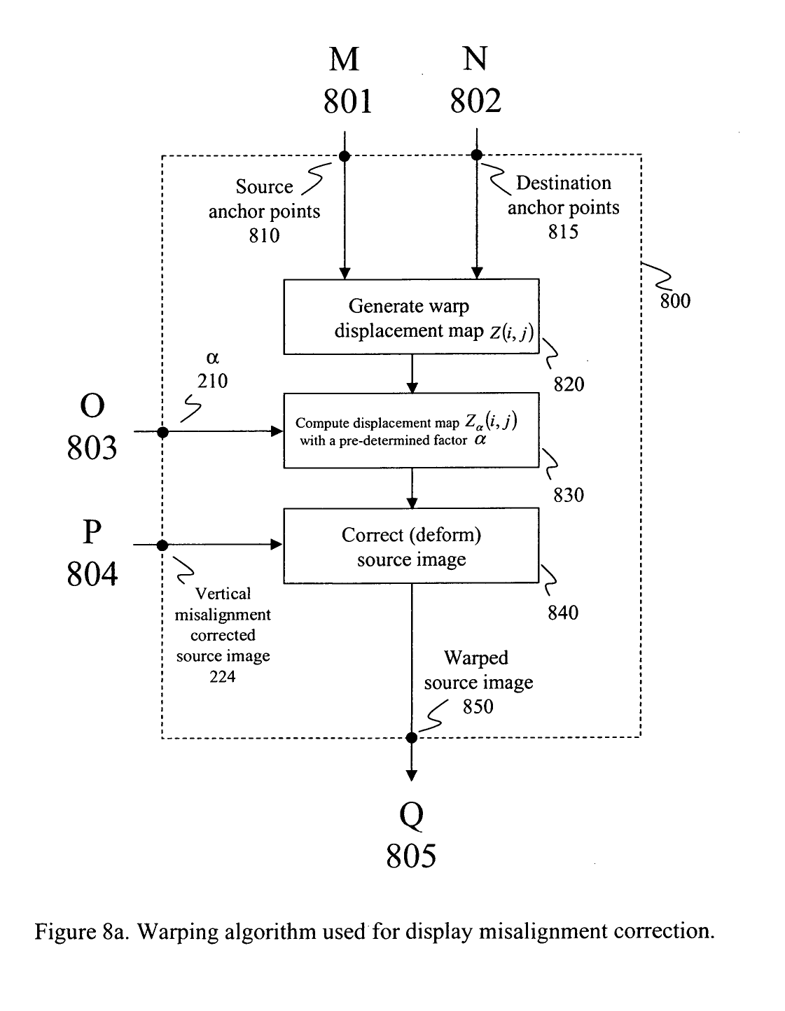

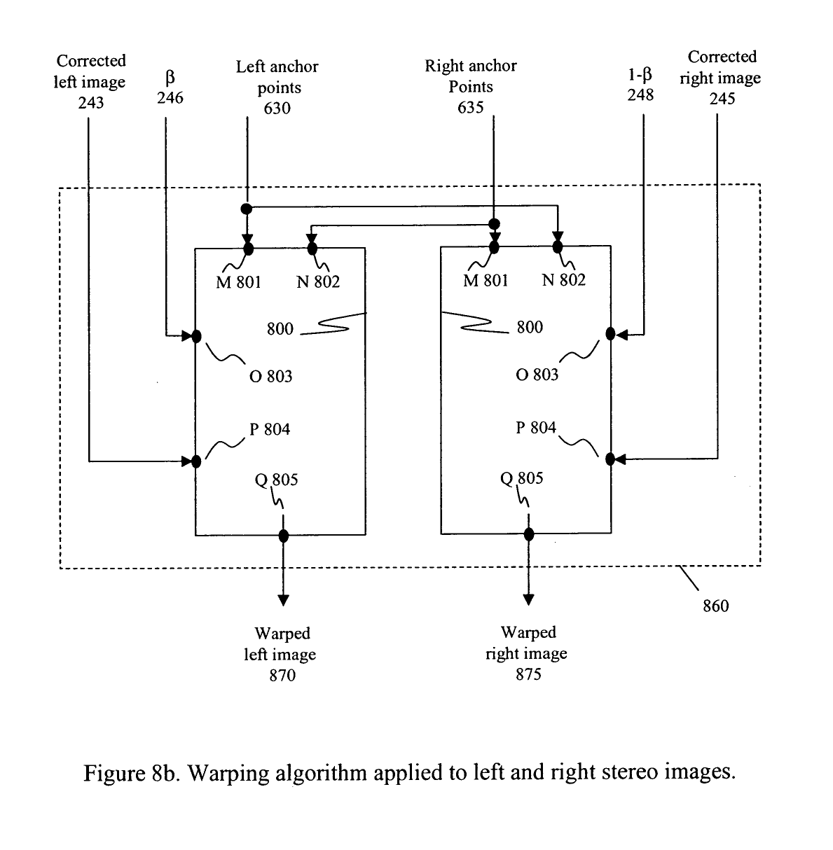

Referring now to FIG. 8a, the flow chart of the method of display distortion misalignment of the present invention is shown. The method is applied to a vertical misalignment corrected source image 224 in order to compensate for additional misalignment introduced by the display system. The method takes as inputs the measured positions of source anchor points 810 and destination anchor points 815. Where the source anchor points indicate the measured locations of the anchor points for the stereo channel corresponding with the source image and the destination anchor points indicate the measured locations of the anchor points for the alternate stereo channel. The anchor points are used to generate a displacement map 820 that specifies how the source image should be warped in order to align with image for the alternate stereo channel.

Persons skilled in the art will recognize that numerous warping algorithms exist to generate a displacement map based on a series of source and destination anchor points. An exemplar method is to connect the anchor points within each image into a grid of line segments and to employ the method for warping based on line segments that is described in Beier, T. and Neely, S., “Feature-Based Image Metamorphosis,” Computer Graphics, Annual Conference Series, ACM SIGGRAPH, 1992, pp. 35-42. Alternate methods have been developed that are based directly on the positions of the anchor points. An exemplar technique is described in Lee, S., Wolberg, G., and Shin, S. Y., “Scattered Data Interpolation with Multilevel B-Splines,” IEEE Transactions on Visualization and Computer Graphics, Vol. 3, No. 3, 1997, pp. 228-244.

As in the case of vertical misalignment correction, to generalize the correction of display misalignment using the displacement map Z(i, j), a working displacement map Z_{α}(i, j) is introduced. The working displacement map Z_{α}(i, j) is computed with a pre-determined factor α of a particular value (step 830) as
Z_{α}(i,j)=αZ(i,j).
where 0≦α≦1. The generated working displacement map Z_{α}(i, j) is then used to deform the source image (step 840) to obtain a warped source image 850. As an alternate embodiment the working displacement maps 206 and 830 could be combined and the deformation operations 208 and 840 could be reduced to a single operation in order to improve the efficiency of the method. The introducing of working displacement Z_{α}(i, j) facilitates the correction of display misalignment for both images (left and right) when the need arises. The process of correction of display misalignment for both images (left and right) is explained below.

As shown in FIG. 8a, the process of display distortion correction can be represented by a box 800 with four input terminals M (801), N (802), O (803), and P (804), and one output terminal Q (805). With this arrangement, the structure of the display misalignment correction for both the vertically corrected left 243 and vertically corrected right 245 images can be constructed as a system 860 shown in FIG. 8b. There are two identical boxes 800 in the system 860. The left anchor points 630 and right anchor points 635 are used as source and destination anchor points for the left image, and the right anchor points 635 and left anchor points 630 are used as source and destination anchor points for the right image. Two scaling factors β (246) and 1−β (248) are used to determine the amount of deformation for the left 243 and right 245 images respectively. These two parameters β (246) and 1−β (248) ensure that the warped left image 870 and right image 875 are aligned to a corresponding position that removes the misalignment introduced by the display system. The valid range for β is 0≦β≦1. When β=0, the warped left image 870 is the input corrected left image 243 and the warped right image 875 aligns with the input corrected left image 243. When β=1, the warped right image 875 is the input corrected right image 245 and the warped left image 870 aligns with the input corrected right image 245. When β≠0 and β≠1, both the left image 243 and right image 245 go through the correction process and the warped left image 870 and warped right image 875 are aligned somewhere between the left image 243 and the right image 245, depending on the value of β.

By applying both the image source displacement map, discussed earlier, and the display displacement map, vertical misalignment in source images and both vertical and horizontal misalignment due to imperfections in the display system can be virtually eliminated. Although, it is preferable that these may each be applied separately, it is desirable that they both be enabled and applied within a system. It is also possible to apply the display displacement map as described herein together with image source displacement maps that are created based on other means, such as those included in U.S. Pat. No. 6,191,809 and EP 1 235 439 A2, both of which are herein included by reference.

The invention has been described with reference to a preferred embodiment. However, it will be appreciated that variations and modifications can be effected by a person of ordinary skill in the art without departing from the scope of the invention.

### PARTS LIST

110 image source
120 image processor
130 rendering processor
140 stereoscopic display device
150 means for obtaining display displacement map
160 storage device
200 image vertical misalignment correction process
202 compute image transformation function step
204 generate vertical displacement map step
206 compute displacement map step
208 deform image step
210 predetermined factor
220 source image
222 reference image
224 vertical misalignment corrected source image
232 input terminal A
234 input terminal B
236 input terminal C
238 output terminal D
240 image processing system
242 left image
243 corrected left image
244 right image
245 corrected right image
246 scaling factor β
248 scaling factor 1−β
302 source image
304 reference image
306 corrected source image
410 displaying test target step
420 capturing left/right images step
430 generating display system displacement map step
440 pre-process input images step
450 display aligned image step
510 left test target
520 right test target
530 left digital video camera
540 right digital video camera
550 video signal mixer
560 color monitor
630 left image anchor points
635 right image anchor points
710 image of overlaid anchor points before correction
720 image of overlaid anchor points after correction
730 anchor locations
800 process of display misalignment correction
801 input terminal M
802 input terminal N
803 input terminal O
804 input terminal P
805 output terminal Q
810 source anchor point positions
815 destination anchor point positions
820 displacement map
830 compute displacement map with pre-determined factor
840 correct (deform) source image
850 warped source image
860 system
870 warped left image
875 warped right image

1. A method for rectifying misalignment in a stereoscopic display system comprising:
providing a pair of input images to an image processor;
creating an image source displacement map for the pair of input images;
obtaining a display displacement map; and
applying the image source displacement map and the display displacement map to the pair of input images to create a rectified stereoscopic image pair.

2. The method for rectifying misalignment in a stereoscopic display system of claim 1 wherein the source displacement map and the display displacement map are combined into a system displacement map and the system displacement map is applied to the pair of input images to create the rectified stereoscopic image pair.

3. The method for rectifying misalignment in a stereoscopic display system of claim 1 wherein the image source displacement map and the display displacement map are individually applied to the pair of input images to create the rectified stereoscopic image pair.

4. The method for rectifying misalignment in a stereoscopic display system of claim 1 wherein the step of obtaining a display displacement map comprises displaying one or more test targets on the display device and determining an alignment of portions of the one or more test targets.

5. The method for rectifying misalignment in a stereoscopic display system of claim 4 wherein the one or more test targets consist of a left and a right eye component which are displayed and in which a user provides feedback to the system regarding a perceived alignment of one or more portions of the left and right eye images to create the display displacement map.

6. The method for rectifying misalignment in a stereoscopic display system of claim 4 wherein an optical apparatus captures left and right eye views of known alignment and the resulting images are processed to determine an alignment of features within the left and right eye views to create the display displacement map.

7. A stereoscopic display system including an image source, an image processing element, and a display in which the image-processing element employs the method of claim 1 to produce a rectified stereoscopic image pair on the display.

8. A method for rectifying misalignment in a stereoscopic display system comprising:
providing a pair of input images to an image processor;
creating an image source displacement map; and
applying the image source displacement map to correct vertical misalignment in the pair of input images.

9. The method for rectifying misalignment in a stereoscopic display system of claim 8 wherein creating the image source displacement map includes:
computing image transformation functions for the pair of input images;
generating vertical displacement maps using the computed transformation functions; and
computing working displacement maps for the pair of input images.

10. The method for rectifying misalignment in a stereoscopic display system of claim 8 wherein the step of applying the image source displacement map to correct the vertical misalignment in the pair of input images includes deforming the pair of input images using computed working displacement maps.

11. An image processing system including an image source, and image processing element and an image output in which the image-processing element employs the method of claim 8 to produce a rectified stereoscopic image pair.

12. A method for rectifying misalignment in a stereoscopic display system comprising:
providing a pair of input images to an image processor;
obtaining a display displacement map; and
applying the display displacement map to the pair of input images to create a rectified stereoscopic display.

13. The method for rectifying misalignment in a stereoscopic display system of claim 12 wherein the step of obtaining a display displacement map includes:
displaying a left and right target;
determining misalignment of features within the left and right targets to generate a display displacement map; and
applying the display displacement map to the pair of input images to create a rectified stereoscopic display.

14. The method for rectifying misalignment in a stereoscopic display system of claim 13 wherein the one or more test targets consist of a left and a right eye component which are displayed and in which a user provides feedback to the system regarding the perceived alignment of one or more portions of the left and right eye images to create the display displacement map.

15. The method for rectifying misalignment in a stereoscopic display system of claim 13 wherein an optical apparatus of known alignment is used to capture left and right eye views and resulting images are processed to determine the alignment of features within the left and right eye views to create the display displacement map.

16. A stereoscopic display system including an image source, an image processing element, and a display in which an image-processing element employs the method of claim 13 to produce a rectified stereoscopic image pair on the display.
